(19) United States
(12) Patent Application Publication
(10) Pub. No.: US 2016/0171604 A1
(43) Pub. Date: Jun. 16, 2016

(54) FINANCIAL INSTRUMENT WITH SELF-COVERING OPTION POSITIONS

(71) Applicant: Scott Nations, Chicago, IL (US)

(72) Inventor: Scott Nations, Chicago, IL (US)

(21) Appl. No.: 15/044,904

(22) Filed: Feb. 16, 2016

Related U.S. Application Data
(63) Continuation of application No. 14/047,685, filed on Oct. 7, 2013.
Application No. 14/047,685 is a continuation-in-part of application No. 11/448,491, filed on Jun. 7, 2006, now abandoned.
(60) Provisional application No. 60/690,069, filed on Jun. 13, 2005.

(51) Int. Cl. G06Q 40/04; G06Q 40/06

(52) U.S. Cl. CPC G06Q 40/04; G06Q 40/06

(57) ABSTRACT

A financial instrument involves creating an underlying asset portfolio and implementing a passive total return strategy into the financial instrument based on writing a covered call option against that same underlying portfolio for a set period and using the premium from selling this new call option to ‘cover’ additional options or option spreads written. The additional options are put option credit spreads, and all option positions are held until expiration, when a new call option is sold, and the premium from that option is used to cover additional options.

### CROSS-REFERENCE TO RELATED APPLICATIONS

This application is a continuation-in-part of non-provisional patent application Ser. No. 11/448,491, filed on Jun. 7, 2006, entitled Financial Instrument With Self-Covering Option Positions, which claims priority from provisional patent application Ser. No. 60/690,069, filed on Jun. 13, 2005, entitled Investment Vehicle With Self-Covering Option Positions. Application Serial Nos. 60/690,069 and 11/488,491 are hereby incorporated by reference in their entirety.

### FIELD OF THE INVENTION

The present invention relates generally to a financial instrument and more particularly to method of creating a financial instrument involving covered calls.

### BACKGROUND

Hedging is often defined as the purchase or sale of a security or derivative, such as options or futures and the like, in order to reduce or neutralize all or some of the risk of holding another security or underlying asset. While there are several ways to hedge equities, one common method is to sell some or all of the potential appreciation in the portfolio in exchange for a cash payment. This ‘covered call’ strategy is generally considered to be an investment strategy in which an investor owns a stock or basket of stocks and sells call options that correspond to the stock or basket of stocks.

An option is a contract between two parties in which one party has the right but not the obligation to do something, usually to buy or sell some underlying asset at a given price, called the exercise price, on or before some given date. Call options give the option holder the right to buy the underlying asset, while put options give the holder the right to sell the underlying asset. In exchange for giving the holder this right the option seller receives cash, known as a premium. The writer of a call option must sell the underlying asset at the predetermined price if the option holder exercises his option prior to expiration while the put option writer must buy the underlying asset at the predetermined price if the put option holder exercises his option prior to expiration.

A ‘covered call’ option is a call option that is sold against the appropriate opposing position in the underlying security such as a stock, a bond, a basket of stocks, or another asset such as an exchange traded fund, a futures contract, a foreign currency or a physical commodity such as gold or silver. The Options Industry Council defines a covered call as: “An option strategy in which a call option is written against an equivalent amount of long stock. Example: writing (selling) 2 XYZ May 60 calls while owning 200 shares or more of XYZ stock.”

A ‘covered put’ is one for which the writer has set aside cash to satisfy the maximum potential loss from the written option. Unlike call options which theoretically can appreciate infinitely, put options have a finite maximum value since the price of an asset cannot drop below zero. In addition to call options being covered by the underlying asset and put options being covered by cash, both types of options can also be covered by a combination of owned options on the underlying asset and cash. The Options Industry Council defines a covered put as: “Cash secured put is an option strategy in which a put option is written against a sufficient amount of cash (Or T-bills to pay for the stock purchase if the short option is assigned).”

The Securities and Exchange Commission (SEC) position is detailed in the Hutton Option Trading, L.P. no action letter, which explains the methods in which options can be ‘covered’.

Closing an option position is different and distinct from covering an option position although the term “cover” is sometimes used colloquially to mean close. For embodiments of the present invention, the terms are distinct and different. The Options Industry Council defines closing as: “A reduction or an elimination of an option position by the appropriate offsetting purchase or sale. An existing long option position is closed by a selling transaction. An existing short option position is closed by a purchase transaction.”

Option credit spreads are generally created when a writer sells one option and buys another wherein the two options are identical but for their strike prices and premiums and the premium received from the option sold is greater than the premium paid for the option purchased, hence the trade is done for a net ‘credit’. In a call option credit spread the strike price of the call option sold is lower than the strike price of the call option purchased. In a put option credit spread the strike price of the put option sold is greater than the strike price of the put option purchased.

Modulating an option position, for the purposes of embodiments of the present invention, is changing the number of additional options or option spreads sold from one option cycle to another, based on the amount of premium received for selling the initial options or a combination of the initial options and the additional options. When options are more expensive, a greater amount of option premium is received for selling the initial covered calls. Since the risk for selling additional puts is fixed by the fact that the price of the underlying instrument cannot drop below zero, the greater amount of premium received when options are expensive means that a greater number of additional options can be sold. Similarly, if the additional options are credit spreads, the risk of the credit spreads is fixed and is independent of the price of the initial options or the additional options, meaning that the greater amount of premium received when options are expensive allows for the sale of a greater number of additional options when options are expensive since the maximum number of additional spreads, such that they can be covered by the premium generated, is sold. Selling a greater number of additional options when options are expensive is desirable.

Similarly, if options are relatively inexpensive a lesser amount of option premium is received for selling the initial options. Since the risk from selling puts and credit spreads is fixed, the lesser amount of initial option premium received means that fewer additional options will be sold when options are relatively inexpensive since the maximum number of additional spread, such that they can be covered by the premium generated, is sold. Selling a lesser number of additional options when options are relatively inexpensive is desirable.

This natural modulation means that from option cycle to option cycle, the number of additional options sold will change with the relative cost of the options. A greater number of options will be sold when options are relatively expensive and a lesser number of options will be sold when options are relatively inexpensive. This desirable or beneficial modulation will, over time, generate superior investment returns.

The modulation results in self-covering options positions. For the purposes of embodiments of the present invention, self-covering option positions are short put options or option credit spreads which are covered by cash generated by selling initial covered calls or by cash generated by selling initial covered calls and the additional options. The option portion of the portfolio is providing the cash to cover a portion of that option portion of the portfolio and is providing all of the cash to cover the additional options, hence the option portion of the portfolio is self-covering the additional options.

Existing and proposed covered option products such as described in United States Patent publication 2003/0225657 disclose selling enough options such that the notional value of the options is equal to the total value of the underlying asset/portfolio. That is, the entirety of the underlying asset/portfolio is needed to cover the options.

One drawback of these traditional covered call strategies is the use of the premium received from selling call options. Generally this premium is plowed back into the portfolio or it is used to purchase interest-bearing instruments. While the latter method somewhat increases the diversification effect it generally yields lower returns. The former method generally yields slightly higher returns but reduces the diversification effect generated by the covered call.

Another drawback of traditional covered call strategies is that they sell call options in the total notional value of the underlying portfolio for every option cycle. There is no mechanism to sell additional options when option prices are relatively high. Any number of objective and subjective tools have been developed to help investors determine whether options are overpriced, fairly priced or underpriced. These judgments have proven to be flawed as evidenced by the general superiority of passive management techniques, such as indexing, over active management techniques, which relies primarily on these subjective judgments.

The SEC has very specific rules and regulations regarding the use of covered option strategies by Regulated Investment Companies in investment vehicles available to the general public. One drawback of another existing covered option strategy such as is described in United States Patent publication 2005/0144107 is that the strategy disclosed is not compliant with current SEC law, for example, the use of margin to cover put options. Thus, such strategies would not be available for use in retail investment products in the United States. In addition, this product does not modulate the number of options sold.

Thus, what is needed is a financial instrument that uses the premium generated from selling covered calls to generate a higher return and that sells more options when option prices are relatively high, and fewer options when option prices are relatively low, while additionally complying with SEC regulations such that the resulting financial instrument can be offered to all investors.

### SUMMARY

A financial instrument in accordance with the principles of the present invention is created wherein a securities portfolio is purchased, covered call options are written against that portfolio, the cash received in the form of option premium is then used to cover additional options or option spreads that are sold. For each option cycle, the portfolio manager simultaneously writes covered call options just above the portfolio forward price and additional options in the form of put options, put option credit spreads, or call option credit spreads such that the maximum potential loss from the additional options written is less than or equal to the premium received from selling the initial call options. The number of additional options is the maximum number that can be covered by the covered call premium received. The portfolio forward price is calculated by compounding the value of the portfolio by its dividend or coupon yield, if any, for the life of the options.

When the options are near expiry they are closed out while simultaneously selling new covered calls and new additional options or option credit spreads which are covered by the premium received from selling the new covered calls. The result is that when options are relatively expensive the premium received from selling the initial covered calls will cover more additional options, thus more additional options are sold. When options are relatively cheap, meaning the initial covered calls will cover fewer additional options, fewer additional options are sold.

In particular, the method of creating a financial instrument includes creating an underlying asset portfolio, writing a covered call option against the underlying asset portfolio, selling additional options such that a premium received from selling the initial call option ‘covers’ the additional options, holding the entire portfolio until the options are closed out, writing a new covered call option against the underlying asset portfolio, and using the premium received from selling the new call option to cover new additional options.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a block diagram view of a specific embodiment of a computer system on which the financial instrument may be implemented in accordance with embodiments of the present invention;

FIGS. 2A-2D represent a single chart of a specific embodiment showing the month-end total return indexes for instruments; and

FIGS. 3A-3B represent a single chart of a specific embodiment showing the properties of the realized monthly returns of the example index.

### DETAILED DESCRIPTION

In accordance with the principles of embodiments of the present invention, a series of financial instruments is created by investing in a portfolio of stocks and writing a nearby, just out-of-the-money call option against the underlying asset portfolio, this call option being covered by ownership of the underlying portfolio. These covered calls are called the initial options.

The new call option may be written and the previously written call option may be repurchased at the close of trading on the day prior to maturity of the previous call option. Maturity is generally the third Friday of each calendar month and is determined in advance of option listing by the relevant exchange.

Simultaneously, additional nearby options or option credit spreads are sold such that the maximum number of additional options or option credit spreads are sold that can be covered by the premium received from selling the new call option. This allows for advantageous or beneficial modulation of the number of options or option credit spreads sold. This modulation or beneficial modulation of the number of covered options or option credit spreads sold is advantageous because a greater number of options or credit spread will be sold when option prices are relatively high, just when an investor would want to sell more of them, and a lesser number of options or option credit spread will be sold when option prices are relatively low, just when an investor would want to sell fewer of them.

These additional options exist simultaneously with the initial options but are executed in a quantity that is determined by the amount of premium received from selling the initial and additional options. These additional options are different and distinct from any options that may have existed previously or that might exist subsequently as a result of a roll.

In one embodiment, the additional option spreads may be put option credit spreads with the strike price of the put option sold immediately below the price of the asset portfolio and the strike price of the put option purchased a fixed percentage below that of the put option sold. Simultaneously, the previous additional options or option credit option spreads are repurchased. Replacing soon-to-expire options with new nearby options is call ‘rolling’.

In accordance with one embodiment of the present invention, existing option positions may be held until expiration and cash settled, at which time a new nearby, just out-of-the-money call and new additional options or option credit spreads may be written.

In another embodiment, an instrument was designed to reflect on a portfolio that invests in Standard & Poors® 500 index stocks that also sells S&P 500® index covered call options and additional covered options or option credit spreads (ticker symbol “SPX”). The S&P 500® is disseminated by Standard & Poor's, 55 Water Street, New York, N.Y. 10041 (“S&P”). S&P 500® index options are offered by the Chicago Board Options Exchange®, 400 S. LaSalle Street, Chicago, Ill. 60605 (“CBOE”). In an alternative embodiment, an index may be designed to reflect on a portfolio that invests in Dow Jones Industrials Average index stocks that also sells Dow Jones Industrials Average index covered call options and additional covered options or option credit spreads (DJX). The Dow Jones Industrials Average index is disseminated by Dow Jones & Company, Dow Jones Indexes, P.O. Box 300, Princeton, N.J. 08543-0300. Dow Jones Industrials Average index options are offered by the Chicago Board Options Exchange (CBOE).

In an alternative embodiment, an exchanged traded fund may be used to reflect a portfolio that invests in Standard & Poor's® 500 index stocks that also sells S&P 500® index covered call options and uses the premium received to cover additional S&P 500® options or option credit spreads. In a further alternative embodiment, an exchange traded fund may be used to reflect on a portfolio that invests in Dow Jones Industrials Average index stocks that also sells Dow Jones Industrial Average index covered calls and additional covered options or option credit spreads.

In another specific embodiment in accordance with the present invention, an instrument may be designed which measures the total rate of return of a strategy applied to the S&P 500 index wherein the covered call options are replaced by covered call option credit spreads such that the total premium generated by the additional put option credit spreads is used to purchase the call to complete the call option credit spreads.

### Example 1

In another embodiment in accordance with the present invention, an instrument may be designed which measures the total rate of return of a hypothetical enhanced covered call strategy applied to the S&P 500 Index. This strategy consists of a portfolio consisting of a long position indexed to the S&P 500 Index on which are sold a succession of one-month options and option spreads on the S&P Index listed on the Chicago Board Options Exchange (CBOE) under the ticker symbol “SPX”. The instrument may be initially assembled by using all the cash available to accumulate the underlying portfolio. In this example, the underlying portfolio replicates the S&P 500. The S&P forward price may be calculated by compounding the underlying portfolio by the S&P 500 dividend yield for the life of the nearby SPX options.

The formula for determining the Forward Price for the next nearby option expiration (assuming the next nearby option expires in one month) is:

Forward Price=S&P500Index*(1+(S&P Index Annual Dividend Yield/12))

The following example uses actual prices from the Feb. 16, 2006 roll. Prior to the close, the level of the S&P 500 Index was 1289.38 and the S&P 500 annual dividend yield was 1.87%. The Forward Price would be:

1291.39=1289.38*(1+(0.0187/12))

The nearby call option with a strike price immediately above this forward price is the call option that will be sold. If the Forward Price is precisely equal to a strike price, then that is the strike price of the covered call. If the Forward Price is precisely equidistant from two strike prices, the strike price closer to at-the-money is used. Generally, SPX option strike prices are listed in 5 point increments. In this example, the strike price for the covered call would be 1295.

In one embodiment the nearby put option with a strike price immediately below this forward price is the put option that will be sold while the strike price of the put option purchased to complete the put option credit spread is the strike price closest to a fixed percentage below the put option sold. If the fixed percentage is equidistant from two strike prices the strike price closest to at-the-money is used. The strike price of the put option purchased may be 5% below the strike price of the put option sold. In the current example, given the Forward Price of 1291.39, the strike price of the put option sold would be 1290. The strike price of the put option purchased to complete the put option credit spread would be calculated by:

Strike Price of the Put Option Sold*0.95

In the current example, this would be:

1225.50=1290*0.95

The strike price closest to 1225.50 is 1225. This is the strike price of the put options to be purchased. Now that the relevant options have been identified, the next calculation determines the number of options and option credit spreads sold. The number of call options sold is the maximum number of whole options that can be considered ‘covered’. The maximum number of covered calls is calculated by:

Number of Covered Calls=Total Assets/Level of the Index/Contract Multiplier

Continuing with the current example, assuming $100 million in assets, the maximum number of covered calls is:

775.566=$100 million/1289.38/100 (the multiplier for CBOE SPX options)

Because contracts exist in whole units this result is rounded down. The number of covered calls would be 775.

The 1295 nearby call option was trading at $10.00 near the close of trading on Feb. 16, 2006. In this example, the total premium received from selling 775 calls would be:

Covered Call Premium Received=Number of Calls*Call Price*Contract Multiplier

In the current example this is:

$775,000=775×10.00×100

This $775,000 will be used to cover the additional options, in this example, the 1290/1225 put option credit spread. The number of additional options sold is calculated by:

Additional Option Credit Spreads=Price of the Covered Call/Width of the Put Option Credit Spread*Number of Covered Calls

In the current example this is calculated by:

119.231=(10/(1290−1225))*775

Because contracts exist in whole units this result is rounded down. The number of additional put option credit spreads sold is 119.

In the above example the nearby 1290/1225 put option credit spread was trading at $11.85. The cash generated from the 119 put option credit spreads would be calculated by:

Additional Premium Received=Number of spreads*Net price realized for each spread*Contract multiplier

In the current example this would be:

$141,015=119*11.85*100

Thus, the total option premium received from selling the initial covered calls and additional options is:

$916,015=$775,000+$141,015

In the current example, if the covered call premium of $775,000 had been simply used to purchase 30-day Treasury Bills, assuming an annualized 30-day Treasury Bill rate of 4.32%, the portfolio would have realized approximately:

$2790=775,000*(4.32%/12)

or $138,225 less than through using the covered call premium to cover additional option credit spreads.

In the current example, if the covered call premium of $775,000 had been reinvested in the underlying asset, in this example, the S&P 500, given an S&P 500 price level of 1289.38 on Feb. 16, 2006 and an S&P 500 price level of 1305.33 on Mar. 16, 2006, the portfolio would have realized approximately:

$9586.75=775,000*((1305.33−1289.38)/1289.38)

or $131,428.25 less than through using the call premium to cover additional put spreads.

If implied volatility was higher the premium received from selling calls would have been greater, more premium would have been available to cover put spreads, more put spreads would have been sold and the premium received from selling those put spreads would have been greater.

Continuing with the previous example: the 1295 nearby call option was trading at $10.00 near the close of trading on Feb. 16, 2006 which implies an annual volatility of 7.86%. If this implied volatility had been 10% higher than this option would have been trading near 11.13. This being the case the total premium received from selling 775 calls would have been:

$862,575=775×11.13×100

or $87,575 greater.

Again, $862,575 would be used to cover the additional options, in our example the 1290/1225 put option credit spread. The number of additional options sold is:

132.704=(11.13/(1290−1225))*775

which is rounded down to 132, so 13 more put option credit spreads would be sold than in the previous example.

With implied volatility 10% higher than the previous example the premium received from selling each put spread would be approximately 13.15. The total would be:

$173,580=132*13.15*100

or $32,565 more than the previous example.

Thus, the total option premium received from selling the initial covered calls and additional options given the higher implied volatility assumptions would be:

$1,036,155=$862,575+173,580

or $120,140 more than in the previous example.

With implied volatility higher, processing in accordance with embodiments of the present invention has not only sold each call option and put option credit spread at a higher price, it has also sold more option spreads.

In another embodiment, the number of additional options is the maximum number that can be covered by the total option premium received from selling the initial covered calls and the additional options.

The following example uses actual prices from the Jul. 15, 2010 roll. Prior to the close, the level of the S&P 500 Index was 1096.48 and the S&P 500 annual dividend yield was 2.07%. The Forward Price would be:

1098.37=1096.48*(1+(0.0207/12))

The nearby call option with a strike price immediately above this Forward Price is the call option that will be sold. In this example, the strike price for the covered call would be 1100.

In this embodiment the strike price of the put that will be sold in the put credit spread that comprise the additional options is the 1095 strike. The strike price of the put option purchased to complete the put option credit spread is calculated by:

1040.25=1095*0.95

The strike closest to 1040.25 is 1040. This is the strike price of the put option purchased to complete the put option credit spread. The put option credit spread sold as the additional options is the 1095/1040 put spread. The number of call options sold is the maximum number of whole options that can be considered “covered”. For SPX options the maximum number of covered calls is calculated by:

Number of Covered Calls=(Total Assets/Level of the Index)/Contract Multiplier

Continuing with this example, assuming $50 million in assets, the maximum number of covered calls is:

456.00466=($50 million/1096.48)/100 (Multiplier for CBOE SPX options)

Because contracts exist in whole units this result is rounded down. The number of covered calls would be 456.

The 1100 nearby call option was trading at $27.00 near the close of trading on Jul. 15, 2010. In this example, the total premium received from selling 456 calls would be:

$1,231,200=456*27.00*100

This $1,231,200 will be used to cover the additional options, in this example, the 1095/1040 put option credit spread. The number of additional options covered by this premium is:

223.8545=(27.00/(1095−1040))*456

Selling the additional options will generate option premium which can be used to cover more of the additional options so the total number of additional options is greater than 223. The number of additional options sold in the current embodiment is calculated by:

((((Price of higher strike put−Price of lower strike put)/(higher strike put option strike price−Lower strike put option strike price))*(Price of call option/(Higher put option strike price−Lower put option strike price)))*Number of calls sold)+((Price of call option/(Higher put option strike price−Lower put option strike price))*Number of calls sold)

In this embodiment, this would be:

286.9408=(((31.50−16.00)/(1095−1040))*(27.00/(1095−1040))*456)+((27.00/(1095−1040))*456)

286.9408 is the number of additional options that can be covered by all of the premium received from selling both the initial covered calls and the additional options. Since option contracts exist in whole units this result is rounded down to 286.

The premium generated by selling the additional options is:

$443,300=286*15.5*100

The total premium collected from selling the initial covered calls and all the additional options is $1,674,500 ($1,231,200+$443,300). These options are allowed to expire when new covered calls and additional options are executed.

In another embodiment, an index measures the performance of the present invention. The following example uses actual prices from the Nov. 20, 2008 roll. The closing value of the S&P 500 Index was 752.44 and the S&P 500 dividend yield was 4.02%. The Forward Price would be:

754.96=752.44*(1+(0.0402/12))

The strike price of the call deemed sold is the strike price immediately above the level of the Forward Price. If the Forward Price is precisely equal to a strike price then that is the strike price of the call deemed sold. SPX option strike prices exist in 5 point increments. In our example, the strike price immediately above 754.96 is 755 thus the call strike price would be 755.

The strike price of the put deemed sold is the strike price immediately below the level of the call strike price. In our example, the short put strike price would be 750.

The strike price of the put deemed bought is the strike price closest to:

Short put strike*0.95

In our example, this would be:

712.5=750*0.95

If the calculation results in a number that is precisely equidistant from two strike prices then the Index uses the strike price nearer to the Forward Price. Thus, the strike price of the put option deemed bought is 715. Once the strike prices of the new options have been identified, the new options are deemed executed at prices equal to the closing prices on the roll date.

The long S&P Index component and the short call option component are deemed to be held in equal notional amounts, i.e. the short position in the call option is precisely “covered” by the long S&P Index component. Put option spreads are deemed sold in an amount such that the premium received from selling call options and put option spreads equals the maximum potential loss of the put option spreads.

The formula for the number of put option spreads deemed sold is calculated in two steps.

Step One:

Price of call option/(Higher put option strike price−lower put option strike price)

For the Nov. 20, 2008 roll this would be:

1.8000=63.00/(750−715)

This is the number of put spreads that are covered by the premium received from selling one call option.

Step Two:

(Price of higher strike put−price of lower strike put)/(Higher strike put option strike price−lower strike put option strike price)*Result of Step One.

In this example this would be:

1.0574=((59.00−38.44)/(750−715))*1.8000

This is the number of put spreads covered by the premium received from selling the put spreads covered by the call premium.

The number of put options deemed sold is the sum of the results of steps one and two. In this example, the number of put option spreads deemed sold is:

2.8574=1.8000+1.0574

This number is called the Coverage Ratio. It is usually significantly less than 1 but the Nov. 20, 2008 roll displayed extraordinarily high implied volatilities.

For purposes of the current embodiment, it is assumed that 1 call option is sold and a fractional put option spread is sold, that fraction being the Coverage Ratio.

### Index Calculation

The index in the current embodiment is a chained index. On any given day, the Index is calculated as follows:

Indexₜ=Indexₜ₋₁*(1+Rₜ)

Where Rₜ is the daily rate of return of the portfolio of stocks replicating the S&P 500, covered calls and additional options. This rate includes ordinary cash dividends paid on the stocks that go “ex-dividend” on that date.

On each trading day the daily gross rate of return of the index equals the change in the value of the components of the portfolio and the value of ordinary cash dividends payable on component stocks that go “ex-dividend” on that date. The gross daily rate of return is:

1+Rₜ=(S&Pₜ+Dividendsₜ−Call Priceₜ−((Higher Strike Put Priceₜ−Lower Strike Put Priceₜ)*Coverage Ratioₜ))/(S&_{Pt-1}−Call Priceₜ₋₁−((Higher Strike Put Priceₜ₋₁−Lower Strike Put Priceₜ₋₁)*Coverage Ratioₜ₋₁))

The Index closing value on Nov. 20, 2008 was 2274.642. On Nov. 21, 2008, the closing values of the portfolio components were: S&P 500 was 800.03, dividends were 0.1630, covered call was 81.40, 750 strike put was 40.50, 715 strike put was 22.50.

1+Rₜ=((800.03+0.1630−81.40−((40.50−22.50)*2.8574))/(752.44−63.00−((59.00−38.44)*2.8574))

### So 1+Rₜ=1.0581

Indexₜ₋₁=1000.00 thus Indexₜ=1000.00*1.0581=1058.10

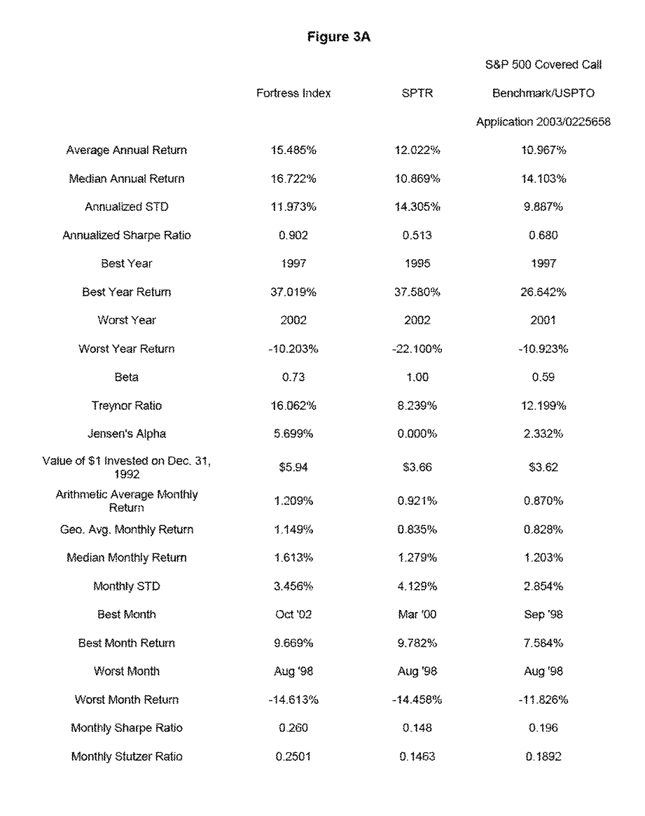

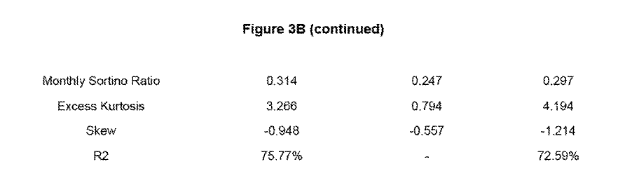

FIGS. 3A-3B list the properties of the realized monthly returns of the example index for 1993 to 2005 inclusive, in accordance with the principles of embodiments of the present invention where Fortress Index^{SM} represents the example index. The properties of monthly returns for the S&P 500 Total Return Index and the covered call benchmark are also listed. The monthly returns were generated by linking daily returns geometrically.

FIGS. 3A-3B show that the average monthly return of the S&P 500 Total Return Index (SPTR) for the 156-month period was 0.921%, while the example index generated an average monthly return of 1.209% and the covered call benchmark generated an average monthly return of 0.870%. In addition to generating greater monthly returns than the SPTR the example index displayed less risk, as measured by the standard deviation of return. For the example index, the standard deviation of monthly returns was 3.456%, while, for the SPTR, the standard deviation was 4.129%. In other words, the example index produced better returns with less risk. The monthly standard deviation of the covered call benchmark was 2.854%. The example index generated monthly returns much greater than the benchmark while assuming only moderately more risk. This is illustrated by the monthly Sharpe Ratios contained in FIGS. 3A-3B. The monthly Sharpe Ratio for the example index was 0.260, while for the SPTR the monthly Sharpe Ratio was 0.148 and for the benchmark it was 0.196. The Sharpe Ratio measures the amount of return generated for each unit of risk assumed. The Sharpe Ratio is calculated as:

Sharpe Ratio=(Period Return−Period Risk Free Rate of Return)/Standard Deviation of Period Returns

### Example 2

### Variable Width Covered Call Option Credit Spreads

In an embodiment in accordance with the present invention, an instrument may be designed which measures the total rate of return of a strategy applied to the S&P 500 index wherein the covered call options are replaced by covered call option credit spreads such that the total premium generated by the additional put option credit spreads is used to purchase the long call portion of the call option credit spreads.

This strategy consists of a portfolio consisting of a long position indexed to the S&P 500 Index on which are sold a succession of one-month option spreads on the S&P Index listed on the Chicago Board Options Exchange (CBOE) under the ticker symbol “SPX”. The instrument may be initially assembled by using all the cash available to accumulate the underlying portfolio. In this example, the underlying portfolio replicates the S&P 500.

The S&P forward price is calculated by compounding the underlying portfolio by the S&P 500 dividend yield for the life of the nearby SPX options. The formula for determining the Forward Price for the next nearby option expiration (assuming the next nearby option expires in one month) is:

Forward Price=S&P500Index*(1+(S&P Index Annual Dividend Yield/12))

The following example uses actual prices from the Feb. 16, 2006 roll. Prior to the close, the level of the S&P 500 Index was 1289.38 and the S&P 500 annual dividend yield was 1.87%. The Forward Price would be:

1291.39=1289.38*(1+(0.0187/12))

The nearby call option with a strike price immediately above this forward price is the call option that will be sold. If the Forward Price is precisely equal to a strike price, then that is the strike price of the covered call. If the Forward Price is precisely equidistant from two strike prices, the strike price closer to at-the-money is used. Generally, SPX option strike prices are listed in 5 point increments. In this example, the strike price for the covered call would be 1295.

In this embodiment the nearby put option with a strike price immediately below this forward price is the put option that will be sold while the strike price of the put option purchased to complete the put option credit spread is the strike price closest to a fixed percentage below the put option sold. If the fixed percentage is equidistant from two strike prices the strike price closest to at-the-money is used. The strike price of the put option purchased may be 5% below the strike price of the put option sold. In the current example, given the Forward Price of 1291.39, the strike price of the put option sold would be 1290. The strike price of the put option purchased to complete the put option credit spread would be calculated by:

Strike Price of the Put Option Sold*0.95

In the current example, this would be:

1225.50=1290*0.95

The strike price closest to 1225.50 is 1225. This is the strike price of the put options purchased.

The long call strike price is the strike price such that the difference between the price of the option and the Long Call Premium Target is closest to zero. The Target is:

Target=(Short Put Option Price−Long Put Option Price)*Put Percentage

The Put Percentage is:

Put Percentage=Value of call spread/Width of put spread

The value of the call spread is the net premium received for selling the call spread. The width of the put spread is the difference between the two put strike prices.

The Long Call Strike is determined by doing the calculations for the likely strike prices and selecting that option for which the difference between the option price and the target is closest to zero. If the absolute value of the differences between two options and the respective targets are equal, the present embodiment uses the option closest to at-the-money.

Continuing with the example:

The price of the 1325 call just prior to the close on February 16th was 2.25. For the 1325 strike price, the Target would be:

1.413=(14.00−2.15)*((10.00−2.25)/(1290−1225))

The difference between 1.413 and 2.25, the price of the 1325 call, is:

−0.837=1.413−2.25

The price of the 1330 call just prior to the close on February 16th was 1.65. For the 1330 strike price, the Target would be:

1.522=(14.00−2.15)*((10.00−1.65)/(1290−1225))

The difference between 1.522 and 1.65, the price of the 1330 call, is:

−0.128=1.522−1.65

The price of the 1335 call just prior to the close on February 16th was 1.10. For the 1335 strike price, the Target would be:

1.623=(14.00−2.15)*((10.00−1.10)/(1290−1225))

The difference between 1.623 and 1.10, the price of the 1335 call, is:

0.523=1.623−1.10

The differences will only increase as we move further away from these strike prices so the option price of the 1330 call is closest to its target. Thus, the 1330 call is the call purchased to complete the call option credit spread.

Now that the relevant options have been identified, the next calculation determines the number of each option spread sold. The number of call option credit spreads sold is the maximum number of whole options that can be considered ‘covered’. The maximum number of covered calls is calculated by:

Number of Covered Call Spreads=Total Assets/Level of the Index/Contract Multiplier

Continuing with the current example, assuming $100 million in assets, the maximum number of covered call spreads is:

775.566=$100 million/1289.38/100 (the multiplier for CBOE SPX options)

Because contracts exist in whole units this result is rounded down. The number of covered call spreads would be 775. The number of put option credit spreads sold would be calculated by:

Number of Put Spreads=(Value of call spread/Width of put spread)*Number of Call Spreads

Continuing with the current example, the number of put spreads is:

99.55=(10.00−1.65)/(1290−1225)*775

Because contracts exist in whole units this result is rounded down. The number of put spreads would be 99.

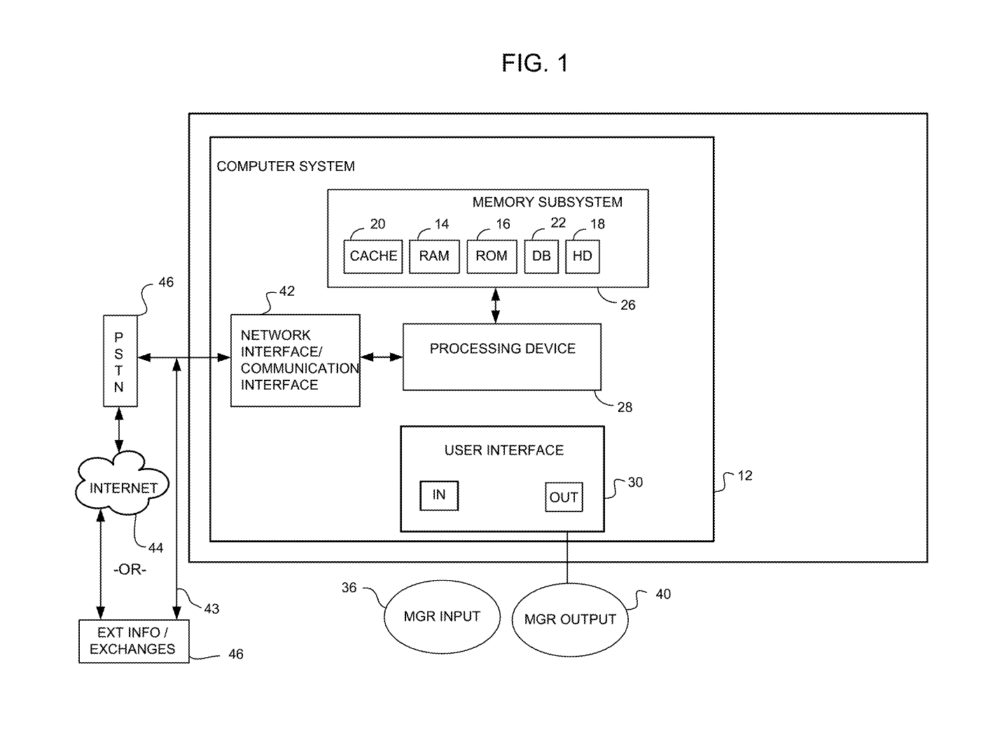

Embodiments of the present invention as described above may be embodied as a system cooperating with computer hardware components, and as a computer-implemented method. Referring now to FIG. 1, a specific embodiment of a high-level hardware block diagram of a computer system on which the above-described financial instrument may be implemented is shown generally. A computer system 10 includes a computer or processing system 12, which includes various hardware components, such as RANI 14, ROM 16, hard disk storage 18, cache memory 20, database storage 22, and the like (also referred to as “memory subsystem” 26), as is known in the art. The computer system 12 may include any suitable processing device 28, such as a computer, microprocessor, RISC processor (reduced instruction set computer), CISC processor (complex instruction set computer), mainframe computer, work station, single-chip computer, distributed processor, server, controller, micro-controller, discrete logic computer and the like, as is known in the art. For example, the processing device 28 may be an Intel Pentium® microprocessor, x86 compatible microprocessor, or equivalent device.

The memory subsystem 26 may include any suitable storage components, such as RAM, EPROM (electrically programmable ROM), flash memory, dynamic memory, static memory, FIFO (first-in first-out) memory, LIFO (last-in first-out) memory, circular memory, semiconductor memory, bubble memory, buffer memory, disk memory, optical memory, cache memory, and the like. Any suitable form of memory may be used whether fixed storage on a magnetic medium, storage in a semiconductor device or remote storage accessible through a communication link.

A user or system manager interface 30 may be coupled to the computer system 12 and may include various input devices 36, such as switches selectable by the system manager and/or a keyboard. The user interface also may include suitable output devices 40, such as an LCD display, a CRT, various LED indicators and/or a speech output device, as is known in the art.

To communicate between the computer system 12 and external sources, a communication interface 42 may be operatively coupled to the computer system. The communication interface 42 may be, for example, a local area network, as an Ethernet network, intranet, Internet or other suitable network 43. The communication interface 42 may also be connected to a public switched telephone network (PSTN) 48 or POTS (plain old telephone system), which may facilitate communication via the Internet 44. Dedicated and remote networks may also be employed and the system may further communicate with external exchanges and sources of information 46. Any suitable commercially available communication device or network may be used, as is known in the art. However, the present methodology may be implemented in a computer system or may be performed by human steps using appropriate communication mediums.

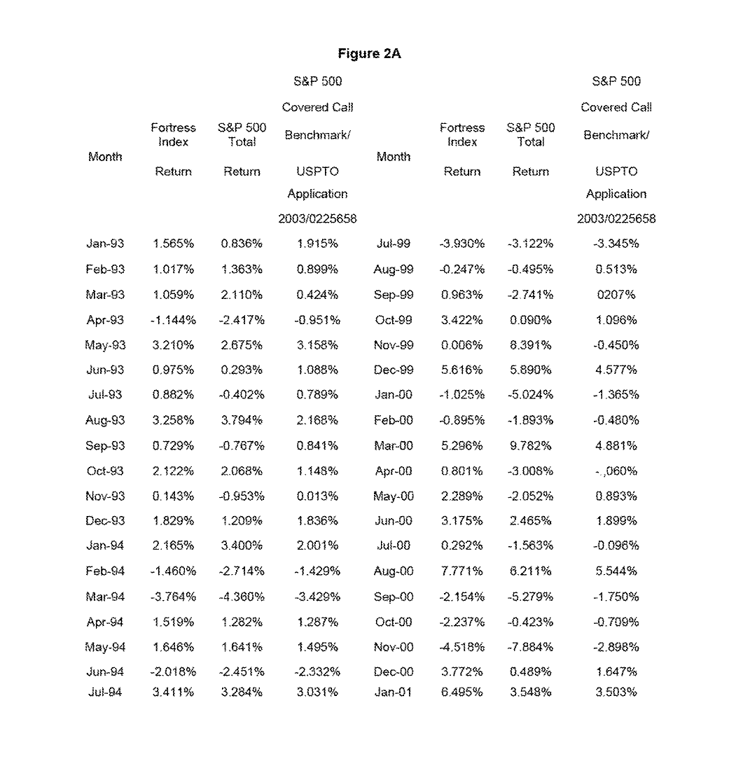

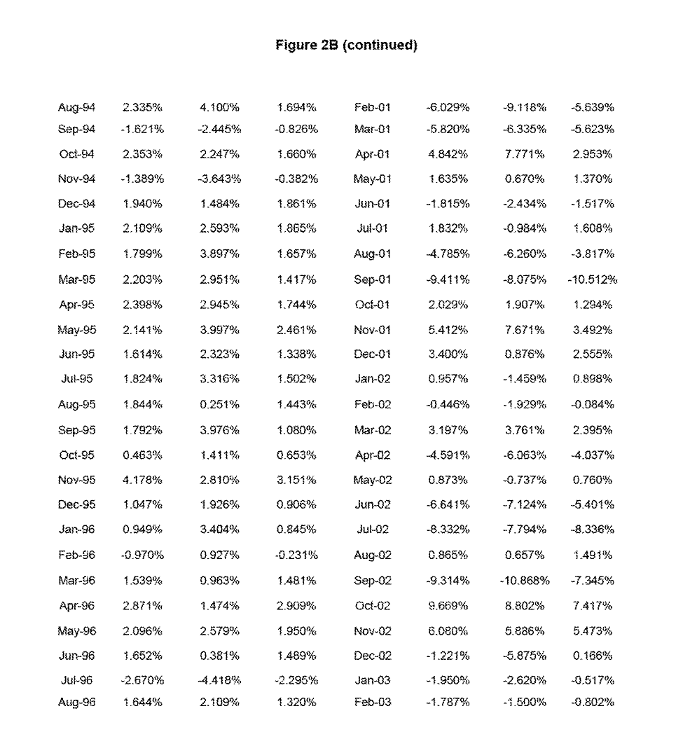

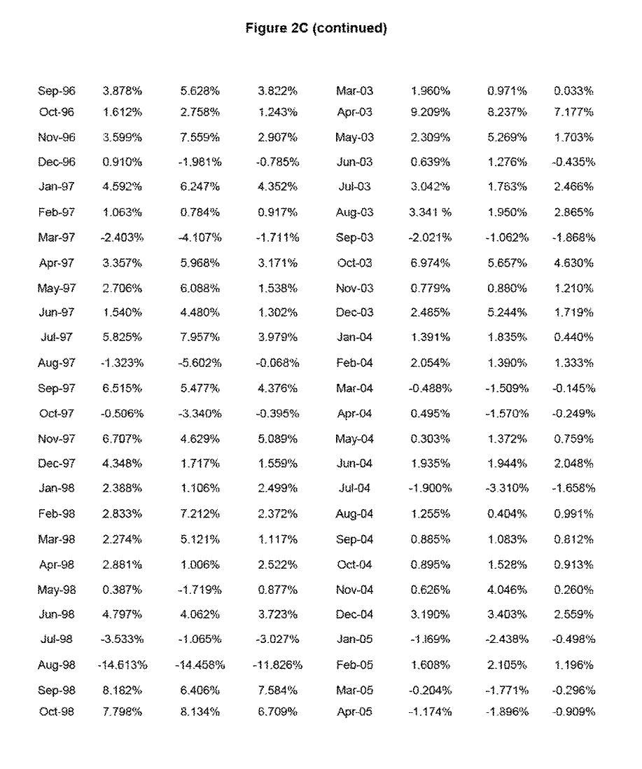

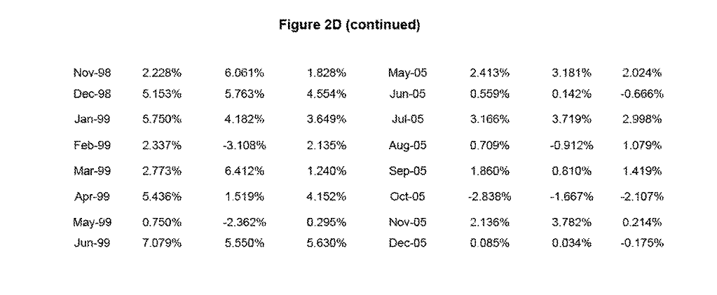

FIGS. 2A-2D represent a single chart of a specific embodiment showing the month-end total return indexes for the S&P 500, the existing covered call benchmark (U.S. Patent Application Publication No. 2003/0225658), and an example index as detailed in example 1, for the period from January 1993 through December 2005; and

FIGS. 3A-3B represent a chart of a specific embodiment showing the properties of the realized monthly returns of the example index as detailed in example 1, as well the properties of the realized monthly returns of the S&P 500 index and the covered call benchmark. The monthly returns were generated by linking daily returns geometrically.

Specific embodiments of a financial instrument with self-covering option positions according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

1-23. (canceled)

24. A computerized method of optimizing a financial instrument comprising:
a processing device electronically defining an underlying asset portfolio;
the processing device electronically facilitating the writing of an initial covered call option against the underlying asset portfolio;
the processing device electronically recording receipt of a premium associated with a sale of the initial covered call option;
the processing device electronically facilitating the sale of additional options in addition to the initial covered call options, wherein the additional options are self-covering as a function of the received premium from the sale associated with the initial covered call option and the additional options, and wherein said self-covering of the additional options facilitates the sale of a greater number of additional options when the additional options are more expensive, and facilitates the sale of a fewer number of the additional options when the additional options are less expensive, so as to improve the underlying asset portfolio; and
the processing device electronically processing the improved underlying asset portfolio by:
holding the initial covered call option and the additional options until an expiration time occurs, and after expiration, executing new initial covered call options and new additional options; or
closing out the initial covered call option and the additional options at a time prior to the expiration time.

25. The method of claim 24, wherein the maximum number of additional options or option credit spreads that can be covered by the total option premium received are sold.

26. The method of claim 24, wherein the initial covered call option is a call option credit spread.

27. The method of claim 24, wherein the additional options are put options.

28. The method of claim 24, wherein the additional options are put option credit spreads.

29. The method of claim 24, wherein the additional options are call option credit spreads.

30. The method of claim 26, wherein the call option credit spreads have a variable width.

31. The method of claim 28, wherein the put option credit spreads have a variable width.

32. The method of claim 24, wherein the underlying asset portfolio comprises a basket of stocks.

33. The method of claim 24, wherein the underlying asset portfolio comprises an exchange-traded fund.

34. The method of claim 24, wherein a strike price of the covered call is just above a compounded price level of the underlying asset portfolio.

35. The method of claim 27, wherein a strike price of the put option is just below a compounded price level of the underlying asset portfolio.

36. The method of claim 26, wherein the initial covered call option credit spreads have a fixed width.

37. The method of claim 26, wherein the initial covered call option credit spreads have a variable width.

38. A computerized method of managing a financial instrument comprising:
a processing device electronically establishing an underlying asset portfolio;
the processing device electronically facilitating the writing of an initial covered call option against the underlying asset portfolio;
the processing device electronically recording receipt of a premium in response to a sale associated with the initial covered call option;
the processing device electronically determining a volume of additional options to sell as a function of the received premium;
the processing device electronically selling the additional options such that the received premium from selling the initial covered call options and the additional options covers the additional options, wherein the additional options are self-covering as a function of the received premium from the sale associated with the initial covered call option and the additional options, and wherein said self-covering of the additional options generates beneficial modulation of the number of options sold by facilitating the sale of a greater number of additional options when the additional options are relatively expensive, and facilitating the sale of a fewer number of the additional options when the additional options are relatively inexpensive, so as to improve the underlying asset portfolio; and
the processing device electronically processing the improved underlying asset portfolio by:
holding the initial covered call option and the additional options until an expiration time occurs, and after expiration, executing new initial covered call options and new additional options; or
closing out the initial covered call option and the additional options at a time prior to the expiration time.

39. The method of claim 38, wherein the maximum number of additional options or option credit spreads than can be covered by the total option premium received are sold.

40. A computer-based system of managing a financial instrument comprising:
a processor;
a memory in communication with the processor, the memory configured to store processor executable instructions wherein the processor executable instructions are configured to:
electronically establish an underlying asset portfolio;
electronically facilitate the writing of an initial covered call option against the underlying asset portfolio;
electronically record the receipt of a premium in response to a sale associated with the initial covered call option;
electronically determine a volume of additional options to sell as a function of the received premium;
electronically facilitate the selling of the determined volume of additional options such that the received premium from selling the initial covered call option covers the determined volume of additional options, wherein the additional options are self-covering as a function of the received premium from the sale associated with the initial covered call option and the additional options, and wherein said self-covering of the additional options facilitates the sale of a greater number of additional options when the additional options are relatively expensive, and facilitates the sale of a fewer number of the additional options when the additional options are relatively inexpensive, so as to improve the underlying asset portfolio; and
electronically process the improved underlying asset portfolio by:
holding the initial covered call option and the additional options until an expiration time occurs, and after expiration, executing new initial covered call options and new additional options; or
closing out the initial covered call option and the additional

41. The method of claim 24, wherein the additional options are covered by cash only and no portion of the additional options are covered by margin.

42. The method of claim 38, wherein the additional options are covered by cash only and no portion of the additional options are covered by margin.

43. The system of claim 40, wherein the additional options are covered by cash only and no portion of the additional options are covered by margin.
